(19) United States
(12) Patent Application Publication
(10) Pub. No.: US 2024/0071363 A1
(43) Pub. Date: Feb. 29, 2024

(54) ELECTRONIC DEVICE AND METHOD OF CONTROLLING TEXT-TO-SPEECH (TTS) RATE

(71) Applicant: SAMSUNG ELECTRONICS CO., LTD., Suwon-si (KR)

(72) Inventors: Jisun CHOI, Suwon-si (KR); Seolhee KIM, Suwon-si (KR); Kyungtae KIM, Suwon-si (KR); Hoseon SHIN, Suwon-si (KR)

(73) Assignee: SAMSUNG ELECTRONICS CO., LTD., Suwon-si (KR)

(21) Appl. No.: 18/372,898

(22) Filed: Sep. 26, 2023

Related U.S. Application Data
(63) Continuation of application No. PCT/KR23/11990, filed on Aug. 11, 2023.

(30) Foreign Application Priority Data
Aug. 26, 2022 (KR) 10-2022-0107387
Oct. 13, 2022 (KR) 10-2022-0131423

(51) Int. Cl. G10L 13/02; G10L 25/00

(52) U.S. Cl. CPC G10L 13/02; G10L 25/00

(57) ABSTRACT

Disclosed are an electronic device and a method of controlling a text-to-speech (TTS) rate. An electronic device may include a processor, and a memory configured to store instructions to be executed by the processor. The processor may receive a voice signal of a user. The processor may calculate a speaking rate of the voice signal based on the voice signal. The processor may generate an output text to be output to the user based on the voice signal. The processor may determine a TTS rate of the output text based on the speaking rate. The processor may convert the output text into voice data based on the TTS rate and output the voice data.

### CROSS-REFERENCE TO RELATED APPLICATIONS

This application is a continuation application of International Application No. PCT/KR2023/011990 designating the United States, filed on Aug. 11, 2023, in the Korean Intellectual Property Receiving Office and claiming priority to Korean Patent Application No. 10-2022-0107387, filed on Aug. 26, 2022, and Korean Patent Application No. 10-2022-0131423, filed on Oct. 13, 2022, in the Korean Intellectual Property Office, the disclosures of which are incorporated by reference herein in their entireties.

### BACKGROUND

### 1. Field

Various embodiments relate to an electronic device and a method of controlling a text-to-speech (TTS) rate.

### 2. Description of Related Art

Current voice assistants directly recognize a user utterance and then output a response suitable for the intent of the user utterance through a natural language understanding process.

However, the current voice assistants maintain a uniformly set text-to-speech (TTS) rate. Thus, a TTS is played back at the same rate even for users having different speaking rates.

### SUMMARY

According to an embodiment, an electronic device includes a processor, and a memory configured to store instructions to be executed by the processor. The processor may receive a voice signal of a user. The processor may calculate a speaking rate of the voice signal based on the voice signal. The processor may generate an output text to be output to the user based on the voice signal. The processor may determine a text-to-speech (TTS) rate of the output text based on the speaking rate. The processor may convert the output text into voice data based on the TTS rate and output the voice data.

According to an embodiment, an electronic device includes a processor, and a memory configured to store instructions to be executed by the processor. The processor may receive a voice signal of a user. The processor may determine a speaking rate level corresponding to the voice signal based on the voice signal.

According to an embodiment, a prosody rate control method of an electronic device includes receiving a voice signal of a user. The method may include calculating a speaking rate based on the voice signal. The method may include generating an output text to be output to the user based on the voice signal. The method may include determining a TTS rate of the output text based on the speaking rate. The method may include converting the output text into voice data based on the TTS rate and outputting the voice data.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device 101 in a network environment 100 according to an embodiment;

FIG. 2 is a block diagram illustrating an integrated intelligence system according to an embodiment;

FIG. 3 is a diagram illustrating a form in which relationship information between concepts and actions is stored in a database according to an embodiment;

FIG. 4 is a diagram illustrating a screen of an electronic device processing a received voice input through an intelligent app according to an embodiment;

FIG. 5 is a block diagram illustrating an electronic device for controlling a text-to-speech (TTS) rate according to an embodiment;

FIG. 6 illustrates an example of a box plot according to an embodiment;

FIG. 7 illustrates another example of a box plot according to an embodiment;

FIG. 8 illustrates properties of a prosody moderator according to an embodiment;

FIG. 9 illustrates a flow of a TTS rate control operation according to an embodiment;

FIG. 10 illustrates an example of a TTS rate control scenario according to an embodiment;

FIG. 11 illustrates another example of a TTS rate control scenario according to an embodiment;

FIG. 12A illustrates an example of a user interface (UI) according to an embodiment;

FIG. 12B illustrates another example of a UI according to an embodiment;

FIG. 13 illustrates a UI for an additional function according to an embodiment;

FIG. 14 illustrates a UI for a TTS rate control function according to an embodiment; and

FIG. 15 is a flowchart illustrating an operation of an electronic device according to an embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

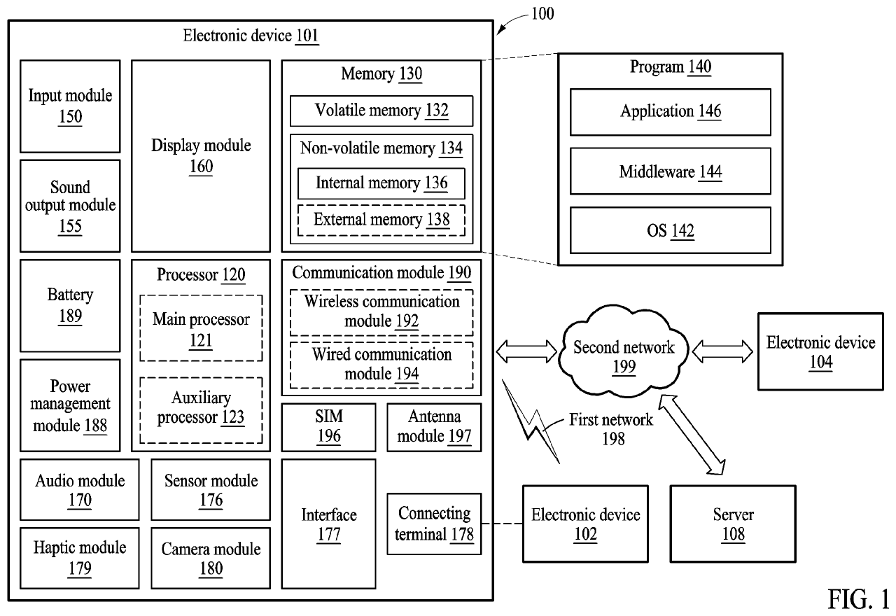

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a portion of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence model processing. An artificial intelligence model may be generated by machine learning. Such learning may be performed by, for example, the electronic device 101 in which an artificial intelligence model is executed, or performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The artificial intelligence model may additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch.

The audio module 170 may convert a sound into an electrical signal or vice versa. According to an embodiment, the audio module 170 may obtain the sound via the input module 150 or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed by the electronic device 101 may be executed at one or more of the external electronic devices 102 and 104, and the server 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least portion of the function or the service requested, or an additional function or an additional service related to the request, and may transfer an outcome of the performing to the electronic device 101. The electronic device 101 may provide the outcome, with or without further processing of the outcome, as at least portion of a reply to the request. To that end, a cloud computing, distributed computing, mobile edge computing (MEC), or client-server computing technology may be used, for example. The electronic device 101 may provide ultra low-latency services using, e.g., distributed computing or MEC. In one embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C”, each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to an embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to embodiments, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

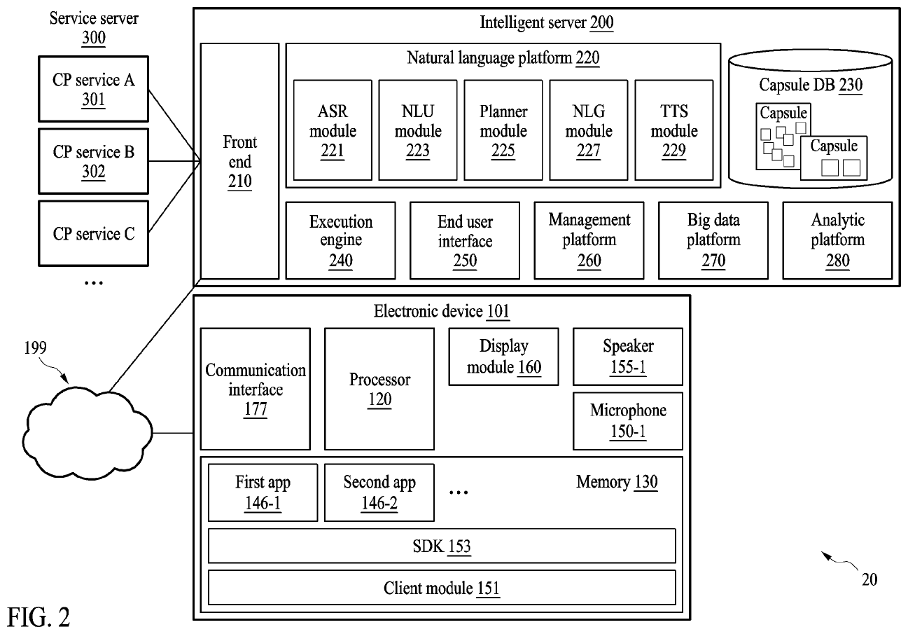

FIG. 2 is a block diagram illustrating an integrated intelligence system according to an embodiment.

Referring to FIG. 2, an integrated intelligence system 20 according to an embodiment may include an electronic device (e.g., the electronic device 101 of FIG. 1), an intelligent server 200 (e.g., the server 108 of FIG. 1), and a service server 300 (e.g., the server 108 of FIG. 1).

The electronic device 101 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

According to the shown embodiment, the electronic device 101 may include a communication interface 177 (e.g., the interface 177 of FIG. 1), a microphone 150-1 (e.g., the input module 150 of FIG. 1), a speaker 155-1 (e.g., the sound output module 155 of FIG. 1), a display module 160 (e.g., the display module 160 of FIG. 1), a memory 130 (e.g., the memory 130 of FIG. 1), or a processor 120 (e.g., the processor 120 of FIG. 1). The components listed above may be operationally or electrically connected to each other.

The communication interface 177 may be connected to an external device and configured to transmit and receive data to and from the external device. The microphone 150-1 may receive a sound (e.g., a user utterance) and convert the sound into an electrical signal. The speaker 155-1 may output the electrical signal as a sound (e.g., a speech).

The display module 160 may be configured to display an image or video. The display module 160 may also display a graphical user interface (GUI) of an app (or an application program) being executed. The display module 160 may receive a touch input through a touch sensor. For example, the display module 160 may receive a text input through a touch sensor in an on-screen keyboard area displayed in the display module 160.

The memory 130 may store a client module 151, a software development kit (SDK) 153, and a plurality of apps 146 (e.g., the application 146 of FIG. 1). The client module 151 and the SDK 153 may configure a framework (or a solution program) for performing general-purpose functions. In addition, the client module 151 or the SDK 153 may configure a framework for processing a user input (e.g., a voice input, a text input, or a touch input).

The plurality of apps 146 stored in the memory 130 may be programs for performing designated functions. The plurality of apps 146 may include a first app 1461, a second app 146_2, and the like. Each of the plurality of apps 146 may include a plurality of actions for performing a designated function. For example, the apps may include an alarm app, a messaging app, and/or a scheduling app. The plurality of apps 146 may be executed by the processor 120 to sequentially execute at least a portion of the plurality of actions.

The processor 120 may control the overall operation of the electronic device 101. For example, the processor 120 may be electrically connected to the communication interface 177, the microphone 150-1, the speaker 155-1, and the display module 160 to perform a designated operation.

The processor 120 may also perform the designated function by executing the program stored in the memory 130. For example, the processor 120 may execute at least one of the client module 151 or the SDK 153 to perform the following operation for processing a user input. The processor 120 may control the operation of the plurality of apps 146 through, for example, the SDK 153. The following operation which is the operation of the client module 151 or the SDK 153 may be performed by the processor 120.

The client module 151 may receive a user input. For example, the client module 151 may receive a voice signal corresponding to a user utterance sensed through the microphone 150-1. As another example, the client module 151 may receive a touch input sensed through the display module 160. As still another example, the client module 151 may receive a text input sensed through a keyboard or an on-screen keyboard. In addition, the client module 151 may receive various types of user inputs sensed through an input module included in the electronic device 101 or an input module connected to the electronic device 101. The client module 151 may transmit the received user input to the intelligent server 200. The client module 151 may transmit state information of the electronic device 101 together with the received user input to the intelligent server 200. The state information may be, for example, execution state information of an app.

The client module 151 may receive a result corresponding to the received user input. For example, when the intelligent server 200 is capable of calculating a result corresponding to the received user input, the client module 151 may receive the result corresponding to the received user input. The client module 151 may display the received result on the display module 160. Further, the client module 151 may output the received result in an audio form through the speaker 155-1.

The client module 151 may receive a plan corresponding to the received user input. The client module 151 may display results of executing a plurality of actions of an app according to the plan on the display module 160. For example, the client module 151 may sequentially display the results of executing the plurality of actions on the display module 160 and output the results in an audio form through the speaker 155-1. As another example, the electronic device 101 may display only a portion of the results of executing the plurality of actions (e.g., a result of the last action) on the display module 160 and output the portion of the results in an audio form through the speaker 155-1.

According to an embodiment, the client module 151 may receive a request for obtaining information necessary for calculating a result corresponding to the user input from the intelligent server 200. According to an embodiment, the client module 151 may transmit the necessary information to the intelligent server 200 in response to the request.

The client module 151 may transmit information on the results of executing the plurality of actions according to the plan to the intelligent server 200. The intelligent server 200 may confirm that the received user input has been correctly processed using the information on the results.

The client module 151 may include a speech recognition module. According to an embodiment, the client module 151 may recognize a voice input for performing a limited function through the speech recognition module. For example, the client module 151 may execute an intelligent app for processing a voice input to perform an organic operation through a designated input (e.g., Wake up!).

The intelligent server 200 may receive information related to a user voice input from the electronic device 101 through a communication network. According to an embodiment, the intelligent server 200 may change data related to the received voice input into text data. According to an embodiment, the intelligent server 200 may generate a plan for performing a task corresponding to the user voice input based on the text data.

According to an embodiment, the plan may be generated by an artificial intelligence (AI) system. The artificial intelligence system may be a rule-based system or a neural network-based system (e.g., a feedforward neural network (FNN) or a recurrent neural network (RNN)). Alternatively, the artificial intelligence system may be a combination thereof or other artificial intelligence systems. According to an embodiment, the plan may be selected from a set of predefined plans or may be generated in real time in response to a user request. For example, the artificial intelligence system may select at least one plan from among the predefined plans.

The intelligent server 200 may transmit a result according to the generated plan to the electronic device 101 or transmit the generated plan to the electronic device 101. According to an embodiment, the electronic device 101 may display the result according to the plan on the display. According to an embodiment, the electronic device 101 may display a result of executing an action according to the plan on the display.

The intelligent server 200 may include a front end 210, a natural language platform 220, a capsule database (DB) 230, an execution engine 240, an end user interface 250, a management platform 260, a big data platform 270, or an analytic platform 280.

The front end 210 may receive the received user input from the electronic device 101. The front end 210 may transmit a response corresponding to the user input.

According to an embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the voice input received from the electronic device 101 into text data. The NLU module 223 may discern an intent of a user using the text data of the voice input. For example, the NLU module 223 may discern the intent of the user by performing syntactic analysis or semantic analysis on a user input in the form of text data. The NLU module 223 may discern the meaning of a word extracted from the user input using a linguistic feature (e.g., a grammatical element) of a morpheme or phrase, and determine the intent of the user by matching the discerned meaning of the word to an intent.

The planner module 225 may generate a plan using a parameter and the intent determined by the NLU module 223. According to an embodiment, the planner module 225 may determine a plurality of domains required to perform a task based on the determined intent. The planner module 225 may determine a plurality of actions included in each of the plurality of domains determined based on the intent. According to an embodiment, the planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the intent of the user. The planner module 225 may determine a relationship between the plurality of actions and the plurality of concepts stepwise (or hierarchically). For example, the planner module 225 may determine an execution order of the plurality of actions determined based on the intent of the user, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) on connections between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an embodiment, some or all of the functions of the natural language platform 220 may be implemented in the electronic device 101 as well.

The capsule DB 230 may store information on the relationship between the plurality of concepts and actions corresponding to the plurality of domains. A capsule according to an embodiment may include a plurality of action objects (or action information) and concept objects (or concept information) included in the plan. According to an embodiment, the capsule DB 230 may store a plurality of capsules in the form of a concept action network (CAN). According to an embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when there are a plurality of plans corresponding to the user input. According to an embodiment, the capsule DB 230 may include a follow-up registry that stores information on follow-up actions for suggesting a follow-up action to the user in a designated situation. The follow-up action may include, for example, a follow-up utterance. According to an embodiment, the capsule DB 230 may include a layout registry that stores layout information that is information output through the electronic device 101. According to an embodiment, the capsule DB 230 may include a vocabulary registry that stores vocabulary information included in capsule information. According to an embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an embodiment, the capsule DB 230 may be implemented in the electronic device 101 as well.

The execution engine 240 may calculate a result using the generated plan. The end user interface 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 may provide a designated service (e.g., food order or hotel reservation) to the electronic device 101. According to an embodiment, the service server 300 may be a server operated by a third party. The service server 300 may provide information to be used for generating a plan corresponding to the received user input to the intelligent server 200. The provided information may be stored in the capsule DB 230. In addition, the service server 300 may provide result information according to the plan to the intelligent server 200.

In the integrated intelligence system 20 described above, the electronic device 101 may provide various intelligent services to the user in response to a user input. The user input may include, for example, an input through a physical button, a touch input, or a voice input.

In an embodiment, the electronic device 101 may provide a speech recognition service through an intelligent app (or a speech recognition app) stored therein. In this case, for example, the electronic device 101 may recognize a user utterance or a voice input received through the microphone, and provide a service corresponding to the recognized voice input to the user.

In an embodiment, the electronic device 101 may perform a designated action alone or together with the intelligent server and/or a service server, based on the received voice input. For example, the electronic device 101 may execute an app corresponding to the received voice input and perform a designated action through the executed app.

In an embodiment, when the electronic device 101 provides a service together with the intelligent server 200 and/or the service server, the electronic device 101 may detect a user utterance using the microphone 150-1 and generate a signal (or voice data) corresponding to the detected user utterance. The electronic device 101 may transmit the voice data to the intelligent server 200 using the communication interface 177.

The intelligent server 200 may generate, as a response to the voice input received from the electronic device 101, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may define parameters input to the execution of the plurality of actions or result values output by the execution of the plurality of actions. The plan may include connection information between the plurality of actions and the plurality of concepts.

The electronic device 101 may receive the response using the communication interface 177. The electronic device 101 may output a voice signal internally generated by the electronic device 101 to the outside using the speaker 155-1, or output an image internally generated by the electronic device 101 to the outside using the display module 160.

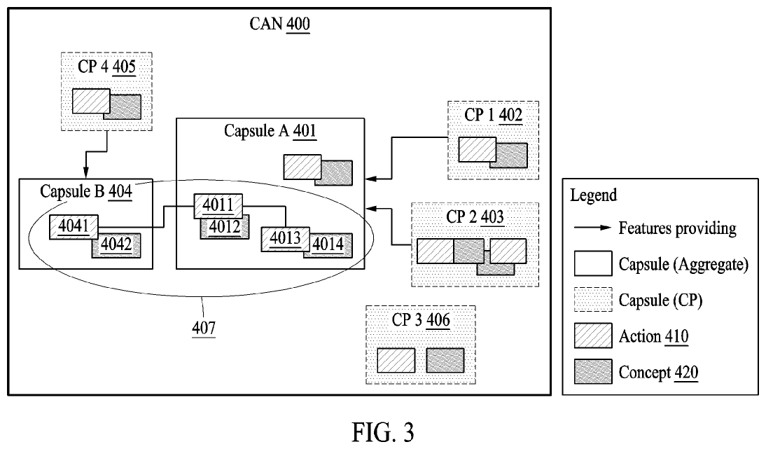

FIG. 3 is a diagram illustrating a form in which relationship information between concepts and actions is stored in a database according to an embodiment.

A capsule DB (e.g., the capsule DB 230) of the intelligent server 200 may store capsules in the form of a concept action network (CAN) 400. The capsule DB may store an action for processing a task corresponding to a voice input of a user and a parameter required for the action in the form of a CAN.

The capsule DB may store a plurality of capsules (a capsule A 401 and a capsule B 404) respectively corresponding to a plurality of domains (e.g., applications). According to an embodiment, one capsule (e.g., the capsule A 401) may correspond to one domain (e.g., a location (geo) or an application). Further, the one capsule may correspond to at least one service provider (e.g., CP 1 402, CP 2 403 or CP 3 406) for performing a function for a domain related to the capsule. According to an embodiment, one capsule may include at least one action 410 for performing a designated function and at least one concept 420.

The natural language platform 220 may generate a plan for performing a task corresponding to the received voice input using the capsules stored in the capsule DB. For example, the planner module 225 of the natural language platform 220 may generate the plan using the capsules stored in the capsule DB. For example, a plan 407 may be generated using actions 4011 and 4013 and concepts 4012 and 4014 of the capsule A 401 and an action 4041 and a concept 4042 of the capsule B 404.

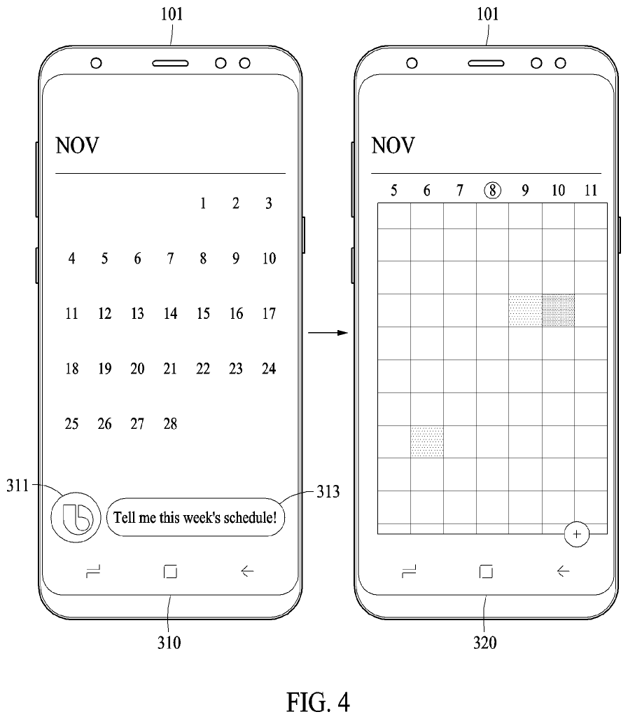

FIG. 4 is a diagram illustrating a screen of an electronic device processing a received voice input through an intelligent app according to an embodiment.

An electronic device (e.g., the electronic device 101 of FIG. 1) may execute an intelligent app to process a user input through an intelligent server (e.g., the intelligent server 200 of FIG. 2).

According to an embodiment, on a screen 310, when a designated voice input (e.g., Wake up!) is recognized or an input through a hardware key (e.g., a dedicated hardware key) is received, the electronic device 101 may execute an intelligent app for processing the voice input. The electronic device 101 may execute the intelligent app, for example, in a state in which a scheduling app is executed. According to an embodiment, the electronic device 101 may display an object (e.g., an icon) 311 corresponding to the intelligent app on the display module 160. According to an embodiment, the electronic device 101 may receive a voice input by a user utterance. For example, the electronic device 101 may receive a voice input of “Tell me this week's schedule!”. According to an embodiment, the electronic device 101 may display a user interface (UI) 313 (e.g., an input window) of the intelligent app in which text data of the received voice input is displayed on the display.

According to an embodiment, on a screen 320, the electronic device 101 may display a result corresponding to the received voice input on the display. For example, the electronic device 101 may receive a plan corresponding to the received user input, and display “this week's schedule” on the display according to the plan.

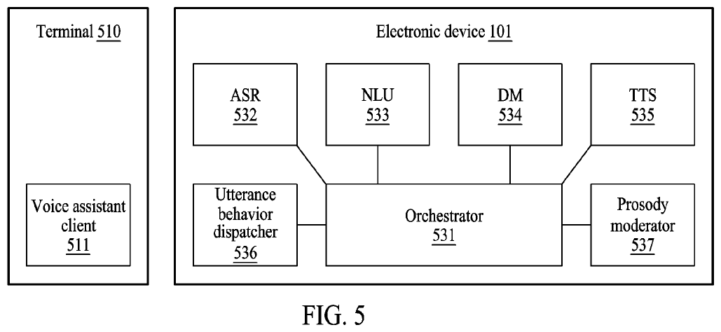

FIG. 5 is a block diagram illustrating an electronic device for controlling a text-to-speech (TTS) rate according to an embodiment.

Referring to FIG. 5, according to an embodiment, the electronic device 101 may control a rate of an utterance output from a terminal 510 by processing a voice signal received from the terminal 510 (e.g., a TTS rate).

According to an embodiment, the terminal 510 may include a voice assistant client 511. The electronic device 101 may include an orchestrator 531, an ASR module 532 (e.g., the ASR module 221 of FIG. 2), an NLU module 533 (e.g., the NLU module 223 of FIG. 2), a dialogue manager (DM) 534, a TTS module 535 (e.g., the TTS module 229 of FIG. 2), an utterance behavior dispatcher 536, and a prosody moderator 537.

According to an embodiment, the ASR module 532, the NLU module 533, the DM 534, the TTS module 535, the utterance behavior dispatcher 536, and the prosody moderator 537 may be included in a processor (e.g., the processor 120 of FIG. 1).

According to an embodiment, the electronic device 101 may control the rate of a final TTS output from the voice assistant client 511 of the terminal 510 based on characteristics of an utterance input from the user. By controlling the rate of a TTS, the electronic device 101 may improve the user's liking by mirroring the language habits or vocabulary of the user through interaction between the voice assistant client 511 and the user, similar to a conversation between people.

According to an embodiment, the electronic device 101 may cause the voice assistant client 511 and the user to mirror the language habits of each other, thereby improving the intimacy of the user and providing an effect that the user communes with the voice assistant client 511.

According to an embodiment, the electronic device 101 may help the user with understanding by reducing the TTS rate for a user having a slow speaking rate or a user unfamiliar with a voice assistant.

According to an embodiment, the electronic device 101 may determine a speaking rate of the user based on ASR information, obtained from the voice signal, including a voice of the user, and adjust the rate of the final TTS of the voice assistant client 511.

According to an embodiment, the electronic device 101 may detect the speaking rate of the user through the ASR module 532. The electronic device 101 may determine a range of the speaking rate of the user, and lower the TTS rate when it is determined that the speaking rate of the user is slow.

According to an embodiment, the electronic device 101 may detect the speaking rate of the user in an ASR operation in which a user instruction is input, and increase the TTS rate when it is determined that the speaking rate of the user is fast.

According to an embodiment, the terminal 510 may be implemented in a personal computer (PC), a data server (e.g., the server 108 of FIG. 1 or the intelligent server 200 of FIG. 2), or a portable device.

The portable device may be implemented as a speaker, earbuds, a virtual reality (VR) device, a laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, or a smart device. The smart device may be implemented as a smart watch, a smart band, or a smart ring.

According to an embodiment, the voice assistant client 511 may transmit the utterance of the user to the electronic device 101. The voice assistant client 511 may include a microphone (e.g., the microphone 150-1 of FIG. 2) for receiving a user utterance, a speaker (e.g., the speaker 155-1 of FIG. 2), and an input device (e.g., a touch screen) into which a text is written. The voice assistant client 511 may perform an action generated in response to the utterance of the user and output a speech using TTS.

According to an embodiment, at least a portion or all of the ASR module 532, the NLU module 533, the DM 534, the TTS module 535, the utterance behavior dispatcher 536, and the prosody moderator 537 may be implemented in the terminal 510. For example, the TTS module 535 and the prosody moderator 537 may be implemented inside the terminal 510.

According to an embodiment, the orchestrator 531 may control the ASR module 532, the NLU module 533, the DM 534, the TTS module 535, the utterance behavior dispatcher 536, and the prosody moderator 537, or control related data flow.

According to an embodiment, the ASR module 532 may receive the voice signal of the user. The ASR module 532 may convert the voice signal into an input text. The ASR module 532 may convert the user utterance input through the voice assistant client 511 into a text form that is processible by the NLU module 533. The ASR module 532 may collect a variety of information from the input utterance of the user. The information collected by the ASR module 532 may include a text of the instruction included in the utterance of the user, an audio length of an input utterance, identification information of a speaker (e.g., the gender of the user, the age of the user, and whether the user is a native speaker or not), and/or noise environment (noise) determination information.

According to an embodiment, the NLU module 533 may analyze the form of the text input through the ASR module 532. The NLU module 533 may understand and determine an intent of the user utterance. The NLU module 533 may classify an intent with high similarity through utterance analysis. The NLU module 533 may process the utterance to determine an action to be finally performed and a response to be output from the TTS module 535. The NLU module 533 may generate an output text to be output to the user based on the voice signal.

According to an embodiment, the DM module 534 may maintain the context of a conversation between the user and the voice assistant. The DM module 534 may determine response information and/or an action to be provided to the user based on the intent obtained by the NLU module 533 and parameter information.

According to an embodiment, when the action to be finally performed is determined, the TTS module 535 may convert text data to be output to conform to the determined action into voice data. The TTS module 535 may transmit the converted voice data so that the voice data may be output from the terminal 510.

According to an embodiment, the utterance behavior dispatcher 536 may calculate the speaking rate of the voice signal based on the voice signal. The utterance behavior dispatcher 536 may determine a speaking rate level corresponding to the voice signal based on the voice signal.

According to an embodiment, the utterance behavior dispatcher 536 may calculate the speaking rate based on a portion or entirety of the input text. The utterance behavior dispatcher 536 may obtain the number of syllables in the portion or entirety of the input text. The utterance behavior dispatcher 536 may calculate the speaking rate based on the duration of uttering the syllables and the number of syllables.

According to an embodiment, the utterance behavior dispatcher 536 may obtain a feature value based on the speaking rate. According to an embodiment, the utterance behavior dispatcher 536 may determine the speaking rate level based on the feature value.

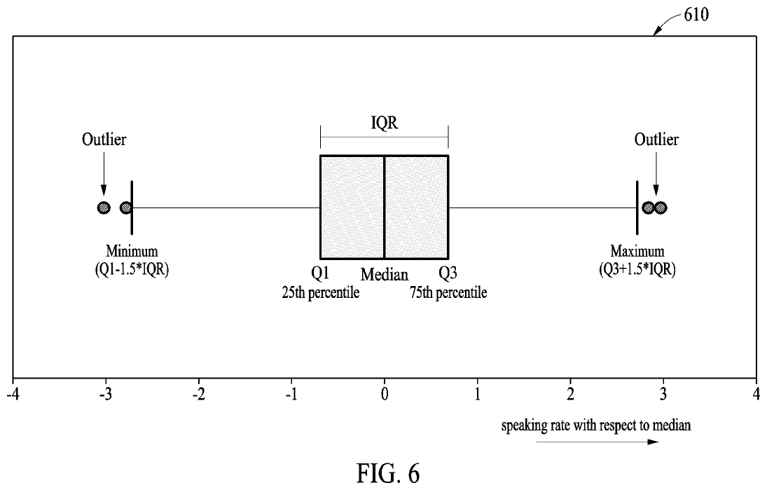

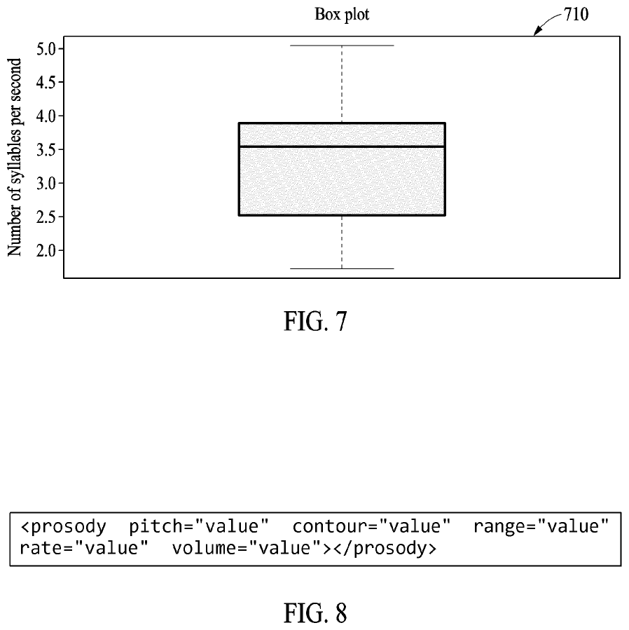

According to an embodiment, the utterance behavior dispatcher 536 may obtain the feature value based on the number of syllables uttered for the duration of uttering, a speaking rate per syllable, or the number of syllables uttered per second. The utterance behavior dispatcher 536 may determine the speaking rate level based on statistics of the feature value. The process of determining the speaking rate level based on the statistics will be described in detail with reference to FIGS. 6 and 7.

According to an embodiment, the utterance behavior dispatcher 536 may obtain the features of the user utterance by processing input information and output information of the ASR module 532. For example, the utterance behavior dispatcher 536 may calculate the speaking rate of the user by analyzing the number of syllables, the speaking rate per syllable, and/or the number of syllables uttered per second based on the utterance text input from the ASR module 532 and an audio time (or audio length) corresponding to the utterance.

According to an embodiment, the utterance behavior dispatcher 536 may determine the speaking rate of the user using various feature values. The utterance behavior dispatcher 536 may calculate the number of syllables uttered per second in a word unit. Alternatively, the utterance behavior dispatcher 536 may use the number of syllables, a speaking rate per syllable, the number of syllables uttered per second, and/or a representative value (e.g., average value, middle value, maximum value, minimum value, or most frequent number) of syllables uttered per second in a word unit. Examples of feature values of the speaking rate may be shown in Table 1.

TABLE 1

| | | | | Speaking | Number of |
|---|---|---|---|---|---|
| | | Audio | Number | rate per | syllables |
| | | length | of | syllable | uttered per |
| # | Uttered text | (seconds) | syllables | (seconds) | second |
| 1 | Set an alarm for 6:30 | 3.46 | 10 | 0.35 | 2.89 |
| 2 | Alarm for 9 | 1.86 | 5 | 0.37 | 2.69 |
| 3 | Alarm in 10 minutes | 1 | 5 | 0.20 | 5.00 |
| 4 | Set an alarm for 7 in the | 4.66 | 11 | 0.42 | 2.36 |
| | morning | | | | |
| 5 | Set an alarm for 10 in the | 5.8 | 10 | 0.58 | 1.72 |
| | morning | | | | |
| 6 | Set an alarm for 7:15 | 2.18 | 11 | 0.20 | 5.05 |
| 7 | Alarm for 9:20 | 2.54 | 8 | 0.32 | 3.15 |
| 8 | Set an alarm for 4:30 | 2.6 | 11 | 0.24 | 4.23 |
| 9 | Cancel the 12:45 alarm and | 7.08 | 28 | 0.25 | 3.95 |
| | ring the alarm in 15 minutes | | | | |
| 10 | Set an alarm for 2:46 | 3.28 | 12 | 0.27 | 3.66 |
| 11 | Alarm for 7:30 | 2.08 | 8 | 0.26 | 3.85 |
| 12 | Set an alarm for 10 | 2.78 | 6 | 0.46 | 2.16 |
| 13 | Alarm for 5:25 | 2.54 | 9 | 0.28 | 3.54 |
| 14 | Alarm for 9 | 2.78 | 5 | 0.56 | 1.80 |
| 15 | Ring the alarm at 9:10 | 2.68 | 10 | 0.27 | 3.73 |

According to an embodiment, the prosody moderator 537 may change the rate (e.g., output rate or speaking rate) of voice data generated by the TTS module 535 based on the speaking rate of the user determined by the utterance behavior dispatcher 536. The prosody moderator 537 may determine a TTS rate of the output text (e.g., a rate at which the output text is converted into a speech) based on the speaking rate.

According to an embodiment, the prosody moderator 537 may adjust the length of a composite sound of syllables constituting the output text (e.g., an output speech of the TTS module 535) based on the TTS rate. The prosody moderator 537 may adjust a speaking length of a voiceless sound and a speaking length of a voiced sound in the output text differently based on the speaking rate. For example, the prosody moderator 537 may adjust only the length of the voiced sound without changing the length of the voiceless portion of the text.

According to an embodiment, the processor 120 of the electronic device 101 may provide a UI for controlling the speaking rate. The processor 120 may compare the TTS rate and a normal speaking rate of the user. The processor 120 may determine a color of an animation to be provided to the user based on a comparison result. The processor 120 may provide the user with the animation with the determined color.

According to an embodiment, the processor 120 may provide the user with one of an output utterance corresponding to the prosody rate or an output utterance corresponding to a predetermined rate in response to a selection of the user.

FIG. 6 illustrates an example of a box plot according to an embodiment, and FIG. 7 illustrates another example of a box plot according to an embodiment. In FIG. 6, the x-axis is speaking rate with respect to a median value. In FIG. 7, the y-axis is number of syllables per second.

Referring to FIGS. 6 and 7, according to an embodiment, an utterance behavior dispatcher (e.g., the utterance behavior dispatcher 536 of FIG. 5) may obtain a feature value based on a speaking rate. According to an embodiment, the utterance behavior dispatcher 536 may determine the speaking rate level based on the feature value.

According to an embodiment, the utterance behavior dispatcher 536 may obtain the feature value based on the number of syllables uttered for the duration of uttering, a speaking rate per syllable, or the number of syllables uttered per second. The utterance behavior dispatcher 536 may determine the speaking rate level based on statistics of the feature value. For example, the statistics may be values calculated based on past utterance inputs of the same speaker. For example, the statistics may be values calculated based on various utterances collected and stored through a plurality of speakers.

According to an embodiment, the utterance behavior dispatcher 536 may determine a speaking rate level by analyzing statistics in the form of a box plot 610 or a box plot 710 based on the speaking rate.

According to an embodiment, the utterance behavior dispatcher 536 may determine whether the speaking rate of the user is within a statistically normal range. The utterance behavior dispatcher 536 may determine a section to which the speaking rate of the user belongs among arbitrarily set rate sections.

According to an embodiment, the utterance behavior dispatcher 536 may determine a rate section or range of the speaking rate of the user using a box plot graph. The utterance behavior dispatcher 536 may obtain a reference value for determining a speaking rate level of a user who generates an audio signal, based on statistics of speaking rates collected from a plurality of users.

According to an embodiment, in the example of FIG. 6, the median value may be the number in the middle of the data distribution. Q1 (the first quartile) and Q3 (the third quartile) may represent the values located at 25% and the values located at 75%, respectively, when the data is arranged in ascending order from the smallest value. The interquartile range (IQR) may be Q3−Q1, and may be the range of a portion corresponding to 50% from 25% to 75%. A minimum value and a maximum value may be defined according to the IQR.

According to an embodiment, the utterance behavior dispatcher 536 may calculate the minimum value and the maximum value as Q1−1.5*IQR and Q3+1.5*IQR, respectively. Values below the minimum value or above the maximum value may be outliers. The utterance behavior dispatcher 536 may define an outlier as a speaking rate level such as very slow or very fast. The utterance behavior dispatcher 536 may define speaking rate levels, for example, define a section of Q1−1.5*IQR to Q1 as slow, a section of Q1 to Q3 as normal speed, and a section of Q3 to Q3+1.5*IQR as fast. The utterance behavior dispatcher 536 may determine the speaking rate levels as shown in Table 2.

TABLE 2

| Speaking rate level | Box plot distinguishing value |
|---|---|
| Very slow | less than Q1 − 1.5*IQR |
| Slow | Q1 − 1.5*IQR to Q1 |
| Normal | Q1 to Q3 section |
| Fast | Q3 to Q3 + 1.5*IQR |
| Very fast | greater than Q3 + 1.5*IQR |

According to an embodiment, the utterance behavior dispatcher 536 may define the speaking rate levels by defining arbitrarily set rate sections, in addition to the method of determining the speaking rate levels using statistics. For example, the utterance behavior dispatcher 536 may determine the speaking rate levels using rate sections using the number of syllables uttered per second as shown in Table 3.

TABLE 3

| Speaking rate level | Number of syllables uttered per second |
|---|---|
| Very slow | less than 1.5 |
| Slow | 1.5 to 2 |
| Normal | 2 to 3 |
| Fast | 3 to 3.5 |
| Very fast | greater than 3.5 |

According to an embodiment, the above-described speaking rate level determination methods are merely examples, and the utterance behavior dispatcher 536 may determine the speaking rate levels using other statistical methods.

According to an embodiment, the utterance behavior dispatcher 536 may store the speaking rate levels defined in the above-described method as the output of the ASR module 532 and finally transmit the speaking rate levels to the TTS module 535. Based on the audio length, user gender, user age, and determination of whether the user is a native speaker or not a native speaker as identified by the ASR module 532, the utterance behavior dispatcher 536 and the prosody moderator 537, in some embodiments, cause the TTS 535 to convert the output text into voice to mirror the language habits of the user.

According to an embodiment, a latency greater than or equal to an expected value may occur from the input of the voice signal of the user into the ASR module 532 to the measurement of a speaking rate by the utterance behavior dispatcher 536. When a latency greater than or equal to the expected value occurs, the utterance behavior dispatcher 536 may reduce the latency by receiving the utterance content input until a preset specific section timeslot (frame), without waiting until the user utterance ends to determine the entire utterance content (utterance text) and the audio length.

According to an embodiment, the utterance behavior dispatcher 536 may set to receive the content uttered by the user only within a frame for a designated time (e.g., 1 to 2 seconds) after the utterance starts, and then determine the speaking rate level by measuring the rate of the utterance content for the designated time.

FIG. 8 illustrates properties of a prosody moderator according to an embodiment.

Referring to FIG. 8, according to an embodiment, a prosody moderator (e.g., the prosody moderator 537 of FIG. 5) may change the rate of voice data generated by the TTS module 535 (e.g., the rate of converting text data into voice data and/or the rate of converting and outputting text data into voice data) based on a speaking rate of a user determined by the utterance behavior dispatcher 536. The prosody moderator 537 may determine a TTS rate of the output text based on the speaking rate.

According to an embodiment, the prosody moderator 537 may adjust the length of a composite sound of syllables constituting the output text based on the TTS rate. The prosody moderator 537 may adjust a speaking length of a voiceless sound and a speaking length of a voiced sound in the output text differently based on the speaking rate.

According to an embodiment, the prosody moderator 537 may change rate attributes of TTS parameters of Speech Synthesis Markup Language (SSML) based on a tag corresponding to the speaking rate level of the user transmitted from the utterance behavior dispatcher 536. FIG. 8 shows examples of the TTS parameters. The TTS parameters may include a pitch, a contour, a range, a rate, and/or a volume. The prosody moderator 537 may adjust the rate at which a TTS is output by changing the rate attribute (corresponding to “rate” in FIG. 8) of the TTS parameter related to the speaking rate.

According to an embodiment, the prosody moderator 537 may adjust the value of the prosody rate attribute based on the speaking rate or speaking rate level transmitted from the utterance behavior dispatcher 536. The prosody moderator 537 may adjust the value of the rate attribute as shown in Table 4. Table 4 is merely an example, and the prosody moderator 537 may set different values of the rate attribute according to embodiments. The value of the rate attribute may indicate a ratio to a TTS reference rate.

TABLE 4

| Speaking rate level | Value of rate attribute |
|---|---|
| Very slow | 0.75 |
| Slow | 0.9 |
| Normal | 1 |
| Fast | 1.1 |
| Very fast | 1.25 |

According to an embodiment, when the speaking rate level is “slow”, the prosody moderator 537 may adjust the value of the rate attribute to 0.9 times the TTS reference rate value. When the speaking rate level is “fast”, the prosody moderator 537 may adjust the value of the rate attribute to 1.1 so as to respond 1.1 times faster than the TTS reference rate.

According to an embodiment, the prosody moderator 537 may adjust the speaking speed of the TTS module 535 using different methods according to a TTS algorithm. If the TTS algorithm is a parametric synthesis method, the prosody moderator 537 may adjust the length of a composite sound by adjusting a syllable length derived during a synthesis process according to the TTS rate (e.g., the rate attribute of the TTS parameter). The prosody moderator 537 may not adjust the length of syllables corresponding to voiceless sounds, but may adjust the length only of syllables corresponding to voiced sounds.

According to an embodiment, if the TTS algorithm is a waveform domain unit concatenation-based synthesis method, the prosody moderator 537 may adjust the length of a composite sound which is the result of synthesis by applying a Pitch Synchronized OverLap Add (PSOLA) or Waveform Similarity OverLap Add (WSOLA) algorithm to the composite sound.

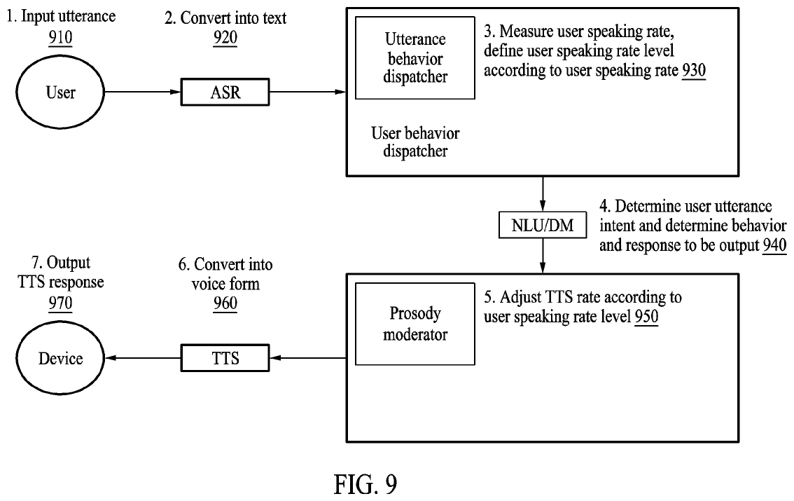

FIG. 9 illustrates a flow of a TTS rate control operation according to an embodiment.

Referring to FIG. 9, according to an embodiment, in operation 910, an ASR module (e.g., the ASR module 532 of FIG. 5) may receive an utterance of a user. In operation 920, the ASR module 532 may convert the utterance of the user into a text.

According to an embodiment, in operation 930, an utterance behavior dispatcher (e.g., the utterance behavior dispatcher 536 of FIG. 5) may determine a speaking rate level by measuring a speaking rate of the user. The utterance behavior dispatcher 536 may calculate the speaking rate of the user based on the converted text and recorded audio length information. The utterance behavior dispatcher 536 may calculate the speaking rate of the user using a speaking rate per syllable or the number of syllables spoken per second. The utterance behavior dispatcher 536 may measure the speaking rate for the entire section from start to end of the user utterance, or may measure the speaking rate using only an utterance input within a frame for a predetermined time (e.g., a few seconds).

According to an embodiment, when the speaking rate of the user is measured, the utterance behavior dispatcher 536 may determine a speaking rate level of the user. The utterance behavior dispatcher 536 may determine the speaking rate level by defining a speaking rate section by calculating statistics of speaking rates, or may determine the speaking rate level using a preset speaking rate section. For example, the speaking rate level may include very slow, slow, normal, fast, or very fast.

According to an embodiment, in operation 940, the NLU module 533 and the DM module 534 may determine an intent of the utterance of the user and determine a response to be output.

According to an embodiment, in operation 950, the prosody moderator 537 may adjust a TTS rate based on the speaking rate level determined by the utterance behavior dispatcher 536. The prosody moderator 537 may set the rate of a TTS to be output according to the speaking rate level. For example, the prosody moderator 537 may set the TTS rate to 0.75 for very slow, 0.9 for slow, 1 for normal, 1.1 for fast, and 1.25 for very fast.

According to an embodiment, in operation 960, the TTS module 535 may convert elements for outputting a TTS into a voice form. In operation 970, the TTS module 535 may output a response with the adjusted TTS rate through a device (e.g., the terminal 510 of FIG. 1).

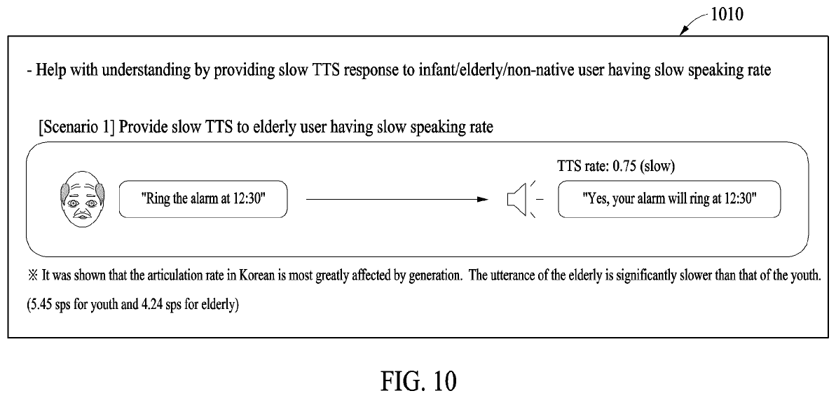

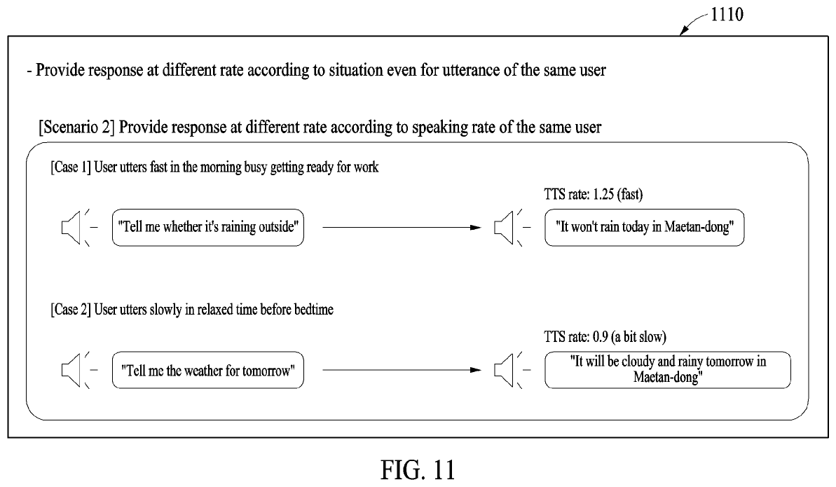

FIG. 10 illustrates an example of a TTS rate control scenario according to an embodiment, and FIG. 11 illustrates another example of a TTS rate control scenario according to an embodiment.

Referring to FIGS. 10 and 11, according to an embodiment, a rate control scenario 1010 of FIG. 10 may be a scenario of providing a slow TTS based on a speaking rate of an elderly user having a slow speaking rate.

According to an embodiment, a rate control scenario 1110 of FIG. 11 may be a scenario of providing, when one user speaks at a different rate according to a situation, a response at a rate appropriate for an utterance having a different speaking rate at a different point in time.

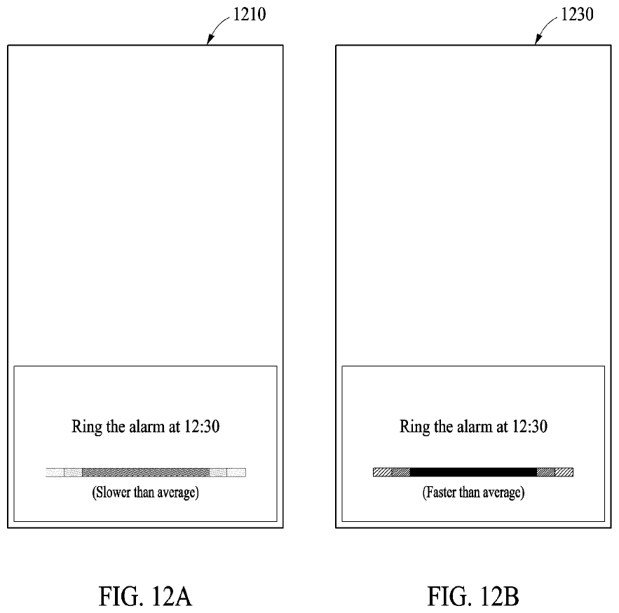

FIGS. 12A and 12B illustrate examples of Us according to an embodiment.

Referring to FIGS. 12A and 12B, according to an embodiment, a processor (e.g., the processor 120 of FIG. 1) may provide a UI for controlling a speaking rate. The processor 120 may determine a speaking rate level. The processor 120 may determine a color of an animation to be provided to a user based on the speaking rate level. The processor 210 may provide the user with the animation with the determined color.

According to an embodiment, the processor 120 may provide the UI through a display module (e.g., the display module 160 of FIG. 1).

According to an embodiment, when an utterance of the user is slow or fast, the processor 120 may inform the user of the speaking rate by changing the color of the animation on the display module. For example, when the rate of the utterance is slow, the processor 120 may provide a UI 1210 indicated in yellow. When the rate of the utterance is fast, the processor 120 may provide a UI 1230 indicated in red. The processor 120 may display, on the display module 160, the value of a speaking rate level corresponding to the rate.

FIG. 13 illustrates a UI for an additional function according to an embodiment.

Referring to FIG. 13, according to an embodiment, when providing a response corresponding to an utterance of a user, a processor (e.g., the processor 120 of FIG. 1) may provide a UI 1310 according to a change in TTS rate through a display module (e.g., the display module 160 of FIG. 1).

According to an embodiment, the processor 120 may display a guide indicating that the rate has changed through the display module 160.

According to an embodiment, the processor 120 may provide the user with additional functions such as “replay at the average rate” and/or “play again at the current rate” through the display module 160.

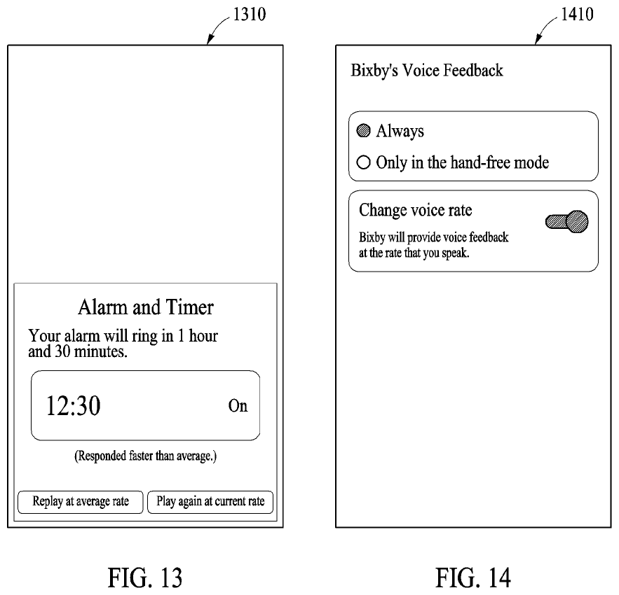

FIG. 14 illustrates a UI for a TTS rate control function according to an embodiment.

Referring to FIG. 14, according to an embodiment, a processor (e.g., the processor 120 of FIG. 1) may provide a UI 1410 for turning on or off a TTS rate control function through a display module (e.g., the display module 160 of FIG. 1).

According to an embodiment, the processor 120 may allow a user to select on or off of a function to control a voice answering rate according to a speaking rate through the UI 1410.

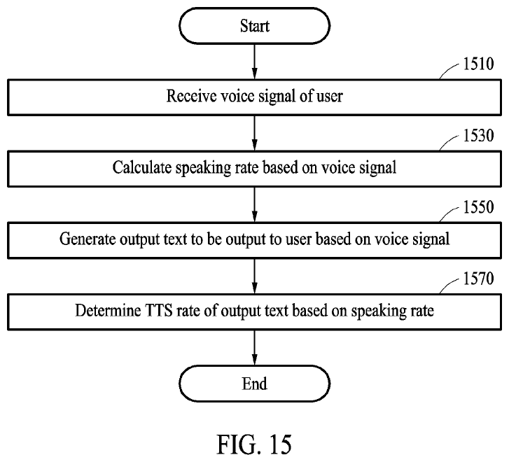

FIG. 15 is a flowchart illustrating an operation of an electronic device according to an embodiment.

Referring to FIG. 15, according to an embodiment, an electronic device (e.g., the electronic device 101 of FIG. 1) may include a processor (e.g., the processor 120 of FIG. 1) and a memory (e.g., the memory 130 of FIG. 1) storing instructions to be executed by the processor 120.

According to an embodiment, in operation 1510, the processor 120 may receive a voice signal of a user. In operation 1530, the processor 120 may calculate a speaking rate of the voice signal based on the voice signal.

According to an embodiment, the processor 120 may convert the voice signal into an input text. The processor 120 may calculate the speaking rate based on a portion or entirety of the input text.

According to an embodiment, the processor 120 may obtain the number of syllables of the portion or entirety of the input text. The processor 120 may calculate the speaking rate based on a duration of uttering the syllables and the number of syllables.

According to an embodiment, the processor 120 may obtain a feature value based on the speaking rate. The processor 120 may determine a speaking rate level based on the feature value.

According to an embodiment, the processor 120 may obtain the feature value based on the number of syllables uttered for the duration of uttering, a speaking rate per syllable, or the number of syllables uttered per second.

According to an embodiment, the processor 120 may determine the speaking rate level based on statistics of the feature value.

According to an embodiment, in operation 1550, the processor 120 may generate an output text to be output to the user based on the voice signal. In operation 1570, the processor 120 may determine a TTS rate of the output text based on the speaking rate.

According to an embodiment, the processor 120 may adjust a speaking length of a voiceless sound and a speaking length of a voiced sound in the output text differently based on the speaking rate.

According to an embodiment, the processor 120 may compare the prosody rate and a normal speaking rate of the user. The processor 120 may determine a color of an animation to be provided to the user based on a comparison result. The processor 120 may provide the user with the animation with the determined color.

According to an embodiment, the processor 120 may provide the user with one of an output utterance corresponding to the TTS rate or an output utterance corresponding to a predetermined rate in response to a selection of the user.

According to an embodiment, an electronic device 101 includes a processor 120, and a memory 130 configured to store instructions to be executed by the processor 120. The processor 120 may receive a voice signal of a user. The processor 120 may calculate a speaking rate of the voice signal based on the voice signal. The processor 120 may generate an output text to be output to the user based on the voice signal. The processor 120 may determine a text-to-speech (TTS) rate of the output text based on the speaking rate. The processor 120 may convert the output text into voice data based on the TTS rate and output the voice data.

According to an embodiment, the processor 120 may convert the voice signal into an input text. The processor 120 may calculate the speaking rate based on a portion or entirety of the input text.

According to an embodiment, the processor 120 may obtain the number of syllables of the portion or entirety of the input text. The processor 120 may calculate the speaking rate based on a duration of uttering the syllables and the number of syllables.

According to an embodiment, the processor 120 may obtain a feature value based on the speaking rate. The processor 120 may determine a speaking rate level based on the feature value.

According to an embodiment, the processor 120 may obtain the feature value based on the number of syllables uttered for the duration of uttering, a speaking rate per syllable, or the number of syllables uttered per second.

According to an embodiment, the processor 120 may determine the speaking rate level based on statistics of the feature value.

According to an embodiment, the processor 120 may adjust a speaking length of a voiceless sound and a speaking length of a voiced sound in the output text differently based on the speaking rate.

According to an embodiment, the processor 120 may compare the TTS rate with a normal speaking rate of the user. The processor 120 may determine a color of an animation to be provided to the user based on a comparison result. The processor 120 may provide the user with the animation with the determined color.

According to an embodiment, the processor 120 may provide the user with one of an output utterance corresponding to the TTS rate or an output utterance corresponding to a predetermined rate in response to a selection of the user.

According to an embodiment, an electronic device 101 includes a processor 120, and a memory 130 configured to store instructions to be executed by the processor 120. The processor 120 may receive a voice signal of a user. The processor 120 may determine a speaking rate level corresponding to the voice signal based on the voice signal.

According to an embodiment, the processor 120 may generate an output text to be output to the user based on the voice signal. The processor 120 may determine a TTS rate of the output text based on the speaking rate level. The processor 120 may adjust a length of a composite sound of syllables constituting the output text based on the TTS rate.

According to an embodiment, the processor 120 may convert the voice signal into an input text. The processor 120 may calculate a speaking rate based on a portion or entirety of the input text. The processor 120 may determine the speaking rate level based on the speaking rate.

According to an embodiment, the processor 120 may obtain the number of syllables of the portion or entirety of the input text. The processor 120 may calculate the speaking rate based on a duration of uttering the syllables and the number of syllables.

According to an embodiment, the processor 120 may obtain a feature value based on the speaking rate. The processor 120 may determine the speaking rate level based on the feature value.

According to an embodiment, the processor 120 may obtain the feature value based on the number of syllables uttered for the duration of uttering, a speaking rate per syllable, or the number of syllables uttered per second.

According to an embodiment, the processor 120 may determine the speaking rate level based on statistics of the feature value.

According to an embodiment, the processor 120 may adjust a speaking length of a voiceless sound and a speaking length of a voiced sound in the composite sound differently based on the speaking rate.

According to an embodiment, the processor 120 may compare the TTS rate with a normal speaking rate of the user. The processor 120 may determine a color of an animation to be provided to the user based on a comparison result. The processor 120 may provide the user with the animation with the determined color.

According to an embodiment, the processor 120 may provide the user with one of an output utterance corresponding to the TTS rate or an output utterance corresponding to a predetermined rate in response to a selection of the user.

According to an embodiment, a prosody rate control method of an electronic device includes receiving a voice signal of a user. The method may include calculating a speaking rate based on the voice signal. The method may include generating an output text to be output to the user based on the voice signal. The method may include determining a TTS rate of the output text based on the speaking rate. The method may include converting the output text into voice data based on the TTS rate and outputting the voice data.

What is claimed is:

1. An electronic device comprising:
a processor; and
a memory configured to store instructions to be executed by the processor,
wherein the processor is configured to:
receive a voice signal of a user,
calculate a speaking rate of the voice signal based on the voice signal,
generate an output text to be output to the user based on the voice signal,
determine a text-to-speech (TTS) rate of the output text based on the speaking rate, and
convert the output text into voice data based on the TTS rate and output the voice data.

2. The electronic device of claim 1, wherein the processor is further configured to:
convert the voice signal into an input text, and
calculate the speaking rate based on a portion or entirety of the input text.

3. The electronic device of claim 2, wherein the processor is further configured to:
obtain a number of syllables of the portion or entirety of the input text, and
calculate the speaking rate based on a duration of uttered syllables and the number of the uttered syllables.

4. The electronic device of claim 1, wherein the processor is further configured to:
obtain a feature value based on the speaking rate, and
determine a speaking rate level based on the feature value.

5. The electronic device of claim 4, wherein the processor is further configured to obtain the feature value based on one or more of a first number of syllables uttered for a duration of uttering, the speaking rate per syllable, or a second number of syllables uttered per second.

6. The electronic device of claim 4, wherein the processor is further configured to determine the speaking rate level based on statistics of the feature value.

7. The electronic device of claim 1, wherein the processor is further configured to adjust a first speaking length of a voiceless sound and a second speaking length of a voiced sound in the output text differently based on the speaking rate.

8. The electronic device of claim 1, wherein the processor is further configured to:
compare the TTS rate with a normal speaking rate of the user,
determine a color of an animation to be provided to the user based on a comparison result, and
provide the user with the animation with the determined color.

9. The electronic device of claim 1, wherein the processor is further configured to provide the user with one of a first output utterance corresponding to the TTS rate or a second output utterance corresponding to a predetermined rate in response to a selection of the user.

10. An electronic device comprising:
a processor; and
a memory configured to store instructions to be executed by the processor,
wherein the processor is configured to:
receive a voice signal of a user,
determine a speaking rate level corresponding to the voice signal based on the voice signal,
generate an output text to be output to the user based on the voice signal,
determine a text-to-speech (TTS) rate of the output text based on the speaking rate level, and
adjust a length of a composite sound of syllables constituting the output text based on the TTS rate.

11. The electronic device of claim 10, wherein the processor is further configured to:
convert the voice signal into an input text, and
calculate a speaking rate based on a portion or entirety of the input text, and
determine the speaking rate level based on the speaking rate.

12. The electronic device of claim 11, wherein the processor is further configured to:
obtain a number of syllables of the portion or entirety of the input text, and
calculate the speaking rate based on a duration of uttered syllables and the number of the uttered syllables.

13. The electronic device of claim 11, wherein the processor is further configured to:
obtain a feature value based on the speaking rate, and
determine the speaking rate level based on the feature value.

14. The electronic device of claim 13, wherein the processor is further configured to obtain the feature value based on one or more of a first number of syllables uttered for a duration of uttering, the speaking rate per syllable, or a second number of syllables uttered per second.

15. The electronic device of claim 13, wherein the processor is further configured to determine the speaking rate level based on statistics of the feature value.

16. The electronic device of claim 10, wherein the processor is further configured to adjust a first speaking length of a voiceless sound and a second speaking length of a voiced sound in the composite sound of syllables differently based on a speaking rate.

17. The electronic device of claim 10, wherein the processor is further configured to:
compare the TTS rate with a normal speaking rate of the user,
determine a color of an animation to be provided to the user based on a comparison result, and
provide the user with the animation with the determined color.

18. The electronic device of claim 10, wherein the processor is further configured to provide the user with one of a first output utterance corresponding to the TTS rate or a second output utterance corresponding to a predetermined rate in response to a selection of the user.

19. A prosody rate control method of an electronic device, the prosody rate control method comprising:
receiving a voice signal of a user;
calculating a speaking rate based on the voice signal;
generating an output text to be output to the user based on the voice signal;
determining a text-to-speech (TTS) rate of the output text based on the speaking rate; and
converting the output text into voice data based on the TTS rate and outputting the voice data.

20. The prosody rate control method of claim 19, wherein the converting further comprises converting the output text into voice data to mirror the language habits of the user.
